(19) United States
(12) Patent Application Publication
(10) Pub. No.: US 2010/0060419 A1
(43) Pub. Date: Mar. 11, 2010

(54) Biometric Control System and Method For Machinery

(76) Inventor: Gaylan S. Smith, Goddard, KS (US)

Correspondence Address: STEVEN N. FOX, ESQ., P.O. BOX 251, CANTON, MA, 02021, US

(21) Appl. No.: 12/554,724

(22) Filed: Sep. 4, 2009

Related U.S. Application Data
(60) Provisional application No. 61/094,428, filed on Sep. 5, 2008.

(51) Int. Cl. G05B 19/00

(52) U.S. Cl. 340/5.83

(57) ABSTRACT

The present invention is a system and method that allows only authorized users to turn on specific equipment they are approved to use and maintains a record of the name of the user, date, time and length of operating time. In one embodiment, the system comprises an AMS unit in communication with a BCS unit located at and connected to the machine. The AMS unit comprises a computing device, a biometric reader connected with the computing device, a storage device connected with the computing device, a programming module stored on the storage unit, and a communication module connected to the computing device. The programming module has sets of code configured to instruct the biometric reader to scan the biometric feature of the operator and to create a digitized biometric signature template. The programming module is further configured to store the biometric signature template within the storage device. The BCS unit comprises a computing device, a biometric reader connected with the computing device, a storage device connected to the computing device, a programming module stored within the storage device, and a communication module connected with the computing device and in communication with the communication module of the AMS unit. The biometric reader of the AMS unit is adapted to detect the presence of the biometric feature of the operator and to scan and create a digitized biometric signature. The programming module of the BCS unit is further configured to turn-on the machine if the biometric signature matches the biometric signature template.

### CROSS-REFERENCE TO RELATED APPLICATIONS

This application claims the benefit of and priority to U.S. Provisional Patent Application Ser. No. 61/094,428 filed on Sep. 5, 2008, now pending, which is hereby incorporated by reference in its entirety into this specification.

### BACKGROUND OF THE INVENTION

Safety is a huge concern with machinery used in the manufacturing industry. Employees using equipment they are not properly trained in the use of exposes the employee to potential peril, as well as exposing the company to potential lawsuits, higher accident and workers compensation rates.

### BRIEF DESCRIPTION OF THE DRAWINGS

The following description of the invention will be fully understood with reference to the accompanying drawings in which:

FIG. 1 is a high level block diagram showing the architecture of a biometric control system according to the present invention;

FIG. 2 is a high level flow chart showing the operation of a central management unit according to the present invention; and

FIG. 3 is a high level flow chart showing the operation of a switch unit according to the present invention.

### SUMMARY OF THE INVENTION

The present invention is a system and method that allows only authorized users to turn on specific equipment they are approved to use and maintains a record of the name of the user, date, time and length of operating time. In one embodiment, the system comprises an AMS unit in communication with a BCS unit located at and connected to the machine. The AMS unit comprises a computing device, a biometric reader connected with the computing device, a storage device connected with the computing device, a programming module stored on the storage unit, and a communication module connected to the computing device. The programming module has sets of code configured to instruct the biometric reader to scan the biometric feature of the operator and to create a digitized biometric signature template. The programming module is further configured to store the biometric signature template within the storage device. The BCS unit comprises a computing device, a biometric reader connected with the computing device, a storage device connected to the computing device, a programming module stored within the storage device, and a communication module connected with the computing device and in communication with the communication module of the AMS unit. The biometric reader of the AMS unit is adapted to detect the presence of the biometric feature of the operator and to scan and create a digitized biometric signature. The programming module of the BCS unit is further configured to turn-on the machine if the biometric signature matches the biometric signature template.

### DESCRIPTION OF THE INVENTION

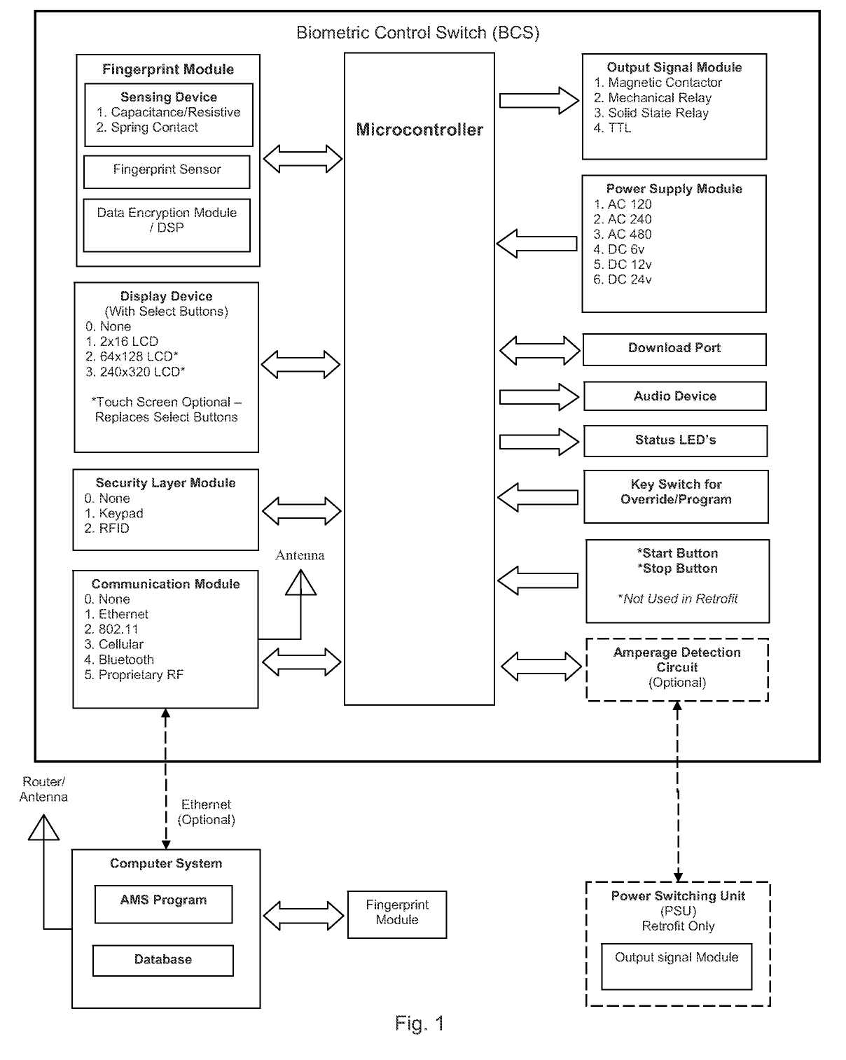

Referring to FIG. 1, the present invention is a system 10 that allows only authorized users to turn on specific equipment they are approved to use and maintains a record of the name of the user, date, time and length of operating time. System 100 generally comprises a central access management system (AMS) 12 and one or more biometric switch units 14 located at and connected with a machine (not shown). Using a finger print reading device 16, the employee's finger print is registered, encrypted, and digitally stored in AMS 12. When an employee turns on a machine or a piece of equipment equipped with a biometric control switch (BCS) 14, the operator's fingerprint is checked against an internal database 18 to either grant or reject access. Using AMS 12, a company has the ability to grant an employee access only to approve machines equipped with BCS 14. AMS 12 is installed on a network and talks to the BCS's using LAN, RF, WIFI, etc interface. When a new user is granted access, or a user is removed from a machine, the system will “talk” to the BCS's and make the appropriate changes. The BCS is capable of logging the user, time, date, and for what length of time a machine was used. This information can be downloaded to the AMS in a network environment, or via local port. The resulting data may be used for any number of purposes. The BCS may also be used as a standalone unit. In this case the users fingerprint would be directly registered to each individual BCS allowing only access to the registered user. The BCS is mounted on the machine, easily accessible to the operator. The BCS contains a fingerprint reader that will check the users fingerprint against an internal database and will either signal the operator that he is authorized and enable power to the control switch, or reject the user using visual and audible means. On existing machinery, a PSU (Power Switching Unit) containing a power contactor is located in the power cord. The BCS is connected to the PSU via a control voltage cable. When a authorized signal is sent to the PSU, the voltage sensing device checks to see if the physical existing machine switch is in the “on” position” by sensing a current draw. If the machine switch happens to be in the “on” position, then the BCS will signal the operator to turn off the machine switch and reinitializing the BCS. This will eliminate the possibility of an unexpected machine start up giving an extra layer of safety. If the machine switch is in the “off” position, the contactor is then energized allowing the power to flow to the machine for normal operation. The BCS will allow a set number of seconds to start up the machine, after which time the BSC will disconnect the PSU. When the operator is finished running the machine, the BCS will sense there is no longer current to the machine and log the user, date, time, and amount of time the machine ran. This information will be uploaded to the AMS when available, or stored in memory until manually downloaded. Each BCS may comprise: (1) a fingerprint Sensor; (2) a sensor CPU; (3) a PIC chip; (4) a WIFI or other RF Module; (5) a network interface jack such as RJ45; (6) a beeper; (7) an indicator LED's; (8) a capacitance/force Sensor to detect finger for reading; (9) an override key switch; and (10) an optional 16×2 LCD display which may have a black background with white letters. Each PSU used for retrofitting comprises a power contactor and a voltage/current sensing circuit. For original equipment (non-retrofit) application, the power contactor and a voltage/current sensing circuit are located in the BCS.

Operational Functions: (1) When not used in a standalone environment, fingerprints are downloaded into the BCS unit via a network or radio frequency via the AMS; (2) Each BCS can store at least 125 users; (3) Uses WIFI 802.11g, network cable, RF, or other type of network interface; (4) User interface is a biometric fingerprint reader (example: fingerprints.com); (5) Uses a capacitance or resistive sensor to determine when a reading is to be taken (Quantum chip & PIC or similar); (6) Uses a beeper and optional LCD to signal fingerprint acceptance, or rejection; (7) Uses a power contactor to control power to enable power to the existing power switch. (retrofit models); (8) Users are updated on instructions from the network through protocol; (9) Checks the voltage out of the existing switch. If already on and will not turn it on; (10) Logs date, time, and person using machine; (11) Resets power control after it senses powering off, (12) BCS multiple amps and voltages i.e. 115, 230, 460; (13) Numerous rejections will notify AMS; (14) Allows x (programmable) seconds to turn on machine after fingerprint is accepted; (15) Key override; and (16) Models using optional LCD —LCD would display users name and status of the machine and any message like “APPROVED”, “TURN POWER OFF”, “MAINTENANCE”, “USER TIMED-OUT”, “USER DENIED”.

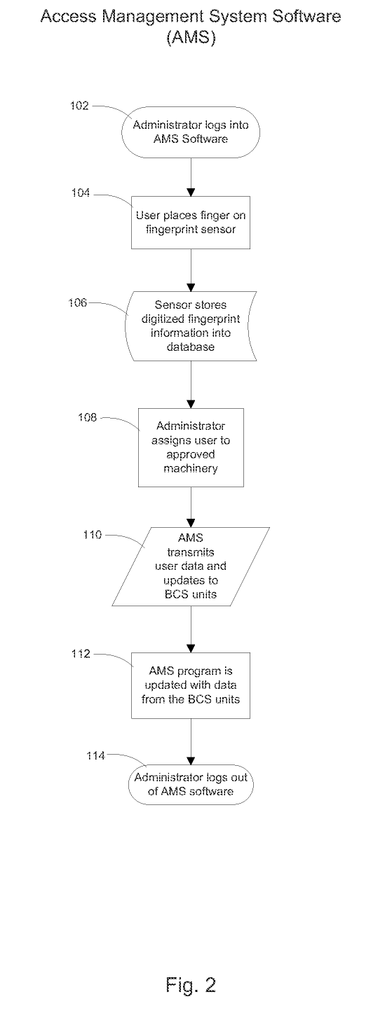

Referring to FIG. 2, and as shown by block 102, a user such an employee places a finger (index finger or thumb) on a finger print reader. Control is passed to block 104 where the finger print is digitized into a data base. Control is passed to block 106 where the AMS is used to select which machines the user is granted access to. Control is passed to block 108 where the AMS is configured to transmit and update new user data to one or more BCS.

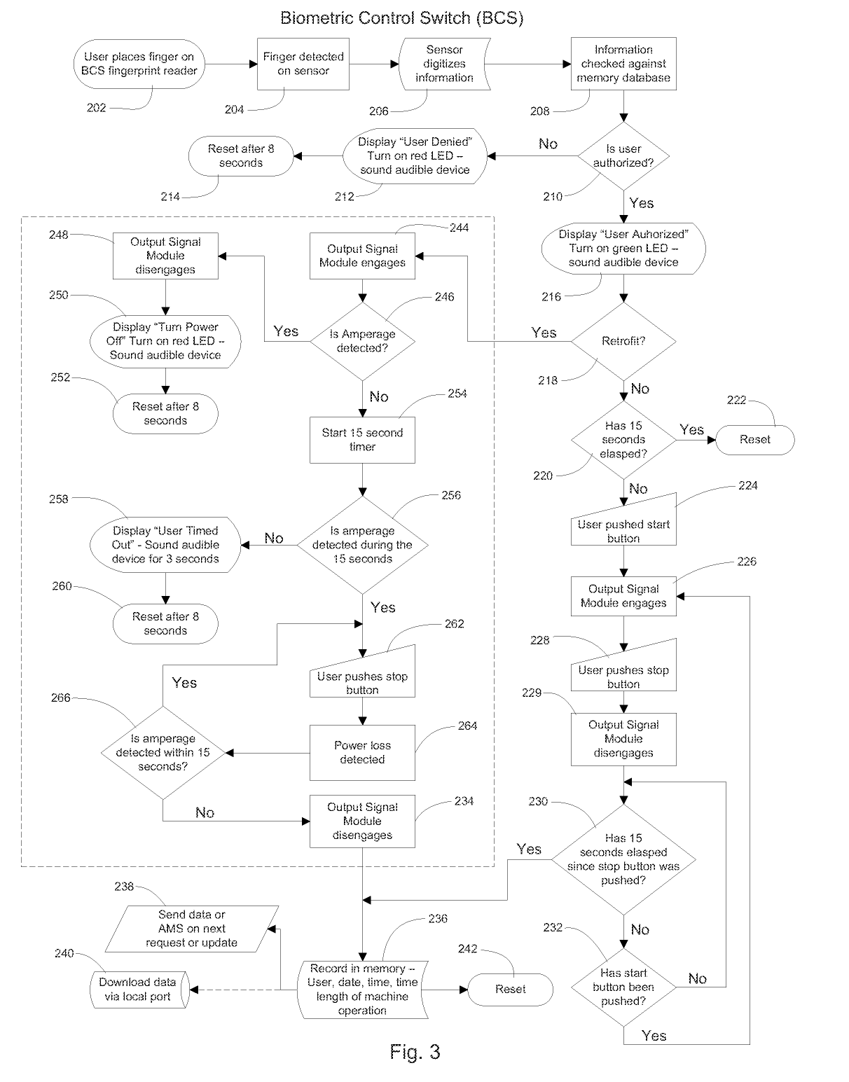

Referring to FIG. 3, and as shown by block 202, a prospective user of a machine such an employee places a finger (index finger or thumb) on a finger print reader associated with the given machine. Control is passed to block 204 where a sensor detects that a finger has been placed on the reader for reading. Control is passed to block 206 where the sensor digitizes the information associated with the finger print. Control is passed to block 208 where the digitized finger print information for the person requesting access to the machine is checked against authorized digitized finger print information stored in a memory data base of the BCS. Control is passed to a decisional block 210 where the BCS decides whether or not the user is authorized. If the user is not authorized control is passed to block 212 where a message such as “User Denied” is displayed and/or a red LCD light is activated and/or an audio beeper is sounded. Control is passed to block 214 where the BCS is reset after a period of time such as eight (8) seconds. Returning to decisional block 210, if the user is authorized the control is passed to block 216 where a message such as “User Approved” is displayed and/or a green LCD light is activated. Control is passed to decisional block 218 where the BCS determines if the application is a retrofit or original. If a non-retrofit application is being employed, control is passed to a decisional block 220 where BCS determines if a given period of time such as fifteen (15) seconds has elapsed. If the fifteen (15) second time period has elapsed then control is passed to block 222 where the control system reset. If the fifteen (15) second time period has not elapsed then control is passed to block 224 where the user pushes the start button of the machine. Control is passed to block 226 where the power contactor is engaged thereby providing power to the machine. Control is passed to block 228 where the user pushes the stop button of the machine which might occur when the user has completed a task or wishes to take a break, or at end of a complete work period on the machine. Control is passed to a decisional block 230 where the BCS determines if a given time period such as fifteen (15) seconds has elapsed since the stop button was pushed or otherwise activated. If the fifteen (15) second time period has not elapsed then control is passed to block 232 where the BCS determines whether or not the start button has been pushed or activated. If the start button has been activated within the fifteen second time period then control is returned to block 226 where the power contactor is engaged thereby providing power back to the machine for continued operation by the same user. If the If the start button has not been activated within the fifteen second time period then control is returned to block 230 where the time period continues to be counted. As shown by decisional block 230, if the fifteen (15) seconds has elapsed since the stop button was pushed or otherwise activated then control is passed to block 243 where the power contactor is turned off. Control is passed to block 236 where the name of the user, date, time and length of operating time is recorded in the BCS memory data base. As shown by block 238, the BCS operates to send or otherwise transmit data to AMS on the next network request or update. As shown by block 240, if the BCS is used as a stand-alone unit then the data may be downloaded via a local port. Control is passed to block 242 where the BCS is reset and status of block 202 where the system waits for another or the same user to place his/her finger on the finger print reader. Returning to decisional block 218, if the BCS is being used in a retro fit application then control is passed to block 244 where the power contactor is engaged. Control is passed to a decisional block 246 where a current sensing circuit operates to detect whether or not a current (amperage) is flowing thru the power contactor. If a current is detected then control is passed to block 248 where the power contactor is turned off. Control is passed to block 250 where a message such as “Turn Power Off” is displayed and/or a red LCD light is activated and/or an audio beeper is sounded for a given time period such as three (3) seconds. Control is passed to block 252 where the BCS is reset after a given period of time such as eight (8) seconds. Returning to decisional block 246, if a current is not sensed control is passed to block 254 where a timer set for a given period of time such as fifteen (15) seconds is initiated or otherwise started. Control is passed to a decisional block 256 where the BCS operates to determine whether a current is detected within the fifteen (15) second time period. If a current is not detected with the fifteen (15) second time period then control is passed to block 258 where a message such as “User Timed Out” is displayed and/or an audio beeper is sounded for a given time period such as three (3) seconds. Control is passed to block 260 where the system is reset. If a current is detected with the fifteen (15) second time period which is indicative that the user has pushed the start button or otherwise activated the machine then control is passed to block 262 where the system waits for the user to push or otherwise activate the stop button of the equipment. Control is passed to block 264 where the system detects a power loss. Control is passed to a decisional block 266 where the system determines whether or not the current is detected within a given time period such as fifteen (15) seconds. If the current is detected within the fifteen (15) second time period then control is returned to block 262 where the system waits for the user to push the stop button of the equipment. Returning to decisional block 266 if a current is not detected within the fifteen (15) second time period then control is passed to block 234 where the power contactor is turned off. Control is passed to block 236 where the name of the user, date, time and length of operating time is recorded in the BCS memory data base. As shown by block 238 and discussed earlier, the BCS operates to send or otherwise transmit data to AMS on the next network request or update. As shown by block 240 and discussed earlier, if the BCS is used as a stand-alone unit then the data may be downloaded via a local port. Control is passed to block 242 where the BCS is reset and status of block 202 where the system waits for another or the same user to place his/her finger on the finger print reader.

The foregoing description is intended primarily for purposes of illustration. This invention may be embodied in other forms or carried out in other ways without departing from the spirit or scope of the invention.

What is claimed:

1. A system for controlling access of one or more operators to a machine, each of the operators has a biometric feature, the system comprising:
an AMS unit in communication with a BCS unit located at and connected to the machine;
said AMS unit comprising a computing device, a biometric reader connected with said computing device, a storage device connected with said computing device, a programming module stored on said storage unit, and a communication module connected to said computing device; said programming module is configured to instruct said biometric reader to scan the biometric feature of the operator and to create a digitized biometric signature template; said programming module is further configured to store said biometric signature template within said storage device; and
said BCS unit comprises a computing device, a biometric reader connected with said computing device, a storage device connected to said computing device, a programming module stored with said storage device, and a communication module connected with said computing device and in communication with said communication module of said AMS unit; said biometric reader is adapted to detect the presence of the biometric feature of the operator and to scan and create a digitized biometric signature; said programming module is further configured to turn-on the machine if said biometric signature matches said biometric signature template.

2. The system of claim 1, wherein said programming module of said AMS module is further configured to cause said communication module to transmit said biometric signature template to said BCS unit; and said programming module of said BCS unit is further configured to store said digitized biometric signature in said storage device of said BCS unit.

3. The system of claim 2, wherein said programming module of said BCS unit is further configured to instruct said communication module of said BCS unit to communicate with said communication module of said AMS unit the data logs of the machine.
